(19) United States
(12) Patent Application Publication
(10) Pub. No.: US 2026/0014726 A1
(43) Pub. Date: Jan. 15, 2026

(54) BLIND CUTTING KIOSK

(71) Applicant: Home Depot Product Authority, LLC, Atlanta, GA (US)

(72) Inventor: Scott L. Hager, Atlanta, GA (US)

(21) Appl. No.: 19/263,227

(22) Filed: Jul. 8, 2025

Related U.S. Application Data
(60) Provisional application No. 63/669,137, filed on Jul. 9, 2024.

(51) Int. Cl. B26D 1/04; B23D 23/00; B26D 5/00; B26D 7/18

(52) U.S. Cl. CPC B26D 1/045; B26D 5/007; B26D 7/1863; B23D 2023/005

(57) ABSTRACT

A blind cutting kiosk includes an input device configured to receive one or more inputs and an output device configured to display one or more outputs. The input device and the output device are configured to display a user interface. The cutting system is configured to receive a vertically arranged window blind.

### CROSS-REFERENCE TO RELATED APPLICATIONS

This application claims priority to U.S. Provisional Application No. 63/669,137, entitled “BLIND CUTTING KIOSK” and filed on Jul. 9, 2024, the entire contents of which are hereby incorporated by reference.

### FIELD

This disclosure relates generally to the field of blind cutting machines. More particularly, this disclosure relates to a blind cutting machine configured for trimming window blinds and shades.

### BACKGROUND

Window blinds and shades come in a variety of different materials and sizes. The windows upon which the window blinds and shades are being installed also come in a variety of sizes. As a result, window blinds and shades can be cut to a particular width to be customized to fit a corresponding window.

### SUMMARY

In some embodiments, a blind cutting kiosk includes an input device configured to receive one or more inputs and an output device configured to display one or more outputs. In some embodiments, the input device and the output device are configured to display a user interface. In some embodiments, a cutting system is configured to receive a vertically arranged window blind.

In some embodiments, the cutting system includes a blade, a motor, and a vertical motion controlled and actuating system.

In some embodiments, the vertical motion controlled and actuating system is configured to move the blade and the motor vertically along a width of the vertically arranged window blind.

In some embodiments, the blind cutting kiosk includes a structure along which the vertical motion controlled and actuating system is configured to move.

In some embodiments, the blind cutting kiosk includes an accessory dispenser configured to dispense an accessory item for the vertically arranged window blind.

In some embodiments, the cutting system is configured to receive the vertically arranged window blind within a product package of the vertically arranged window blind.

In some embodiments, the blind cutting kiosk includes at least one of a Radio Frequency Identification (RFID) reader, a photo eye, a camera, a QR code reader, or a barcode reader.

In some embodiments, the RFID reader is configured to read an RFID tag associated with the vertically arranged window blind to determine whether the vertically arranged window blind matches an expected window blind.

In some embodiments, the blind cutting kiosk includes a packaging dispenser configured to dispense one or more pieces of tape, an end cap, cover material, or combinations thereof for the vertically arranged window blind.

In some embodiments, a blind cutting system includes a blind cutting kiosk. In some embodiments, a blind cutting kiosk includes an input device configured to receive one or more inputs and an output device configured to display one or more outputs. In some embodiments, the input device and the output device are configured to display a user interface. In some embodiments, a cutting system is configured to receive a vertically arranged window blind. In some embodiments, the blind cutting system includes a server device configured to electrically communicate with the blind cutting kiosk via a network.

In some embodiments, the cutting system includes a blade, a motor, and a vertical motion controlled and actuating system.

In some embodiments, the vertical motion controlled and actuating system is configured to move the blade and the motor vertically along a width of the vertically arranged window blind.

In some embodiments, the blind cutting system includes a structure along which the vertical motion controlled and actuating system is configured to move.

In some embodiments, the blind cutting system includes an accessory dispenser configured to dispense an accessory item for the vertically arranged window blind.

In some embodiments, the cutting system is configured to receive the vertically arranged window blind within a product package of the vertically arranged window blind.

In some embodiments, the blind cutting system includes at least one of a Radio Frequency Identification (RFID) reader, a photo eye, a camera, a QR code reader, or a barcode reader.

In some embodiments, the server device is configured to receive information relating to usage of the blind cutting kiosk.

In some embodiments, a method includes receiving one or more blind selections via an input device on a blind cutting kiosk. In some embodiments, the one or more blind selections define a custom dimension of a window blind. In some embodiments, in response to an indication that a payment for the window blind is complete, the method includes cutting a window blind using the custom dimension of the window blind. In some embodiments, the method includes dispensing one or more of tape segments or accessory products from the blind cutting kiosk.

In some embodiments, the method includes receiving the window blind, wherein the window blind is contained within packaging.

In some embodiments, the method includes reading, by a Radio Frequency Identification (RFID) reader, an RFID tag associated with the window blind. In some embodiments, in response to the RFID tag matching an expected RFID tag based on the one or more blind selections, the method includes cutting the window blind using the custom dimension of the window blind.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 shows a schematic diagram for a blind cutting system, according to some embodiments.

FIG. 2 shows a schematic diagram for a blind cutting kiosk within the blind cutting system of FIG. 1, according to some embodiments.

FIG. 3 shows a flowchart of a method for resizing a window blind, according to some embodiments.

FIG. 4 shows a flowchart of a method for cutting a window blind, according to some embodiments.

FIG. 5 is a diagrammatic view of an illustrative computing system, according to some embodiments.

Like reference numbers represent the same or similar parts throughout.

### DETAILED DESCRIPTION

Window blinds and shades come in a variety of different materials and sizes. For example, window blinds and shades can include cellular window blinds and shades having a plurality of honeycomb cells, faux wood blinds, or roller shades. The windows upon which the window blinds and shades are being installed also come in a variety of sizes. As a result, window blinds and shades may need to be cut to a particular width to be customized to fit a corresponding window. Embodiments of this disclosure relate to a blind cutting machine that is configured to be located within a retail store so that window blinds and shades can be customized to fit a customer's need within the store, for being shipped to a customer directly, or for a scenario in which the customer purchases online and picks up the order in the store. In some embodiments, this can avoid a waiting process in which customer's otherwise order window blinds and shades online and wait for them to be cut and shipped to the customer or a retail store for pickup. More specifically, embodiments of this disclosure relate to improved safety features for a blind cutting machine to protect an operator, individuals nearby the blind cutting machine, and components of the blind cutting machine when used to trim window blinds and shades. In some embodiments, the blind cutting machine can be located in a warehouse or the like (i.e., non-retail store location) that, for example, fulfills orders for cut-to-width orders submitted via an electronic store of the retailer. In some embodiments, the customer can be responsible for inputting their desired dimensions and can pay for the order (e.g., online) before the order is shipped, avoiding errors by a store associate.

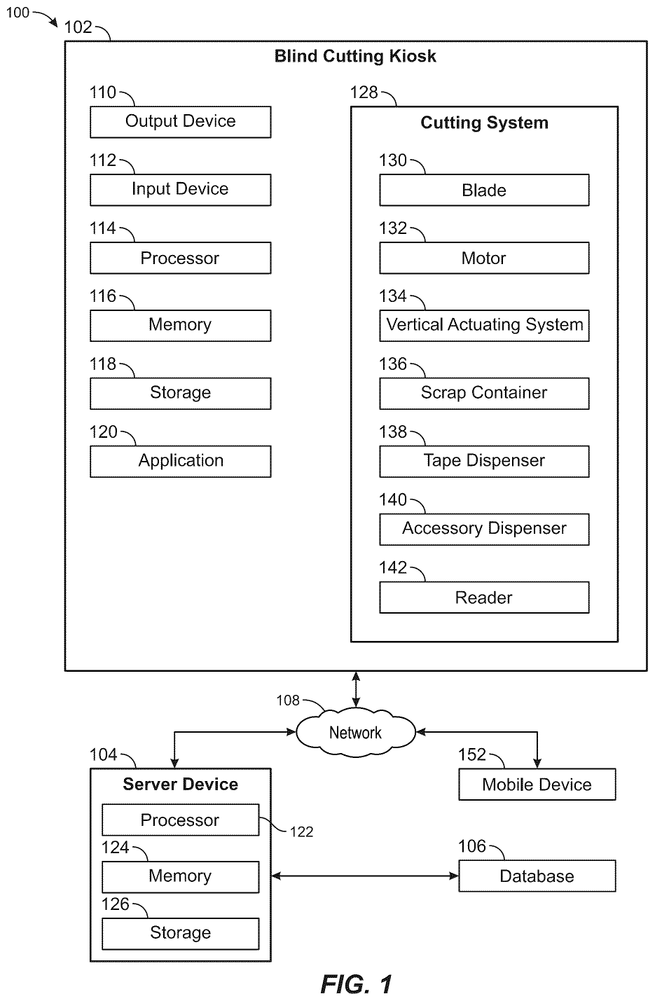

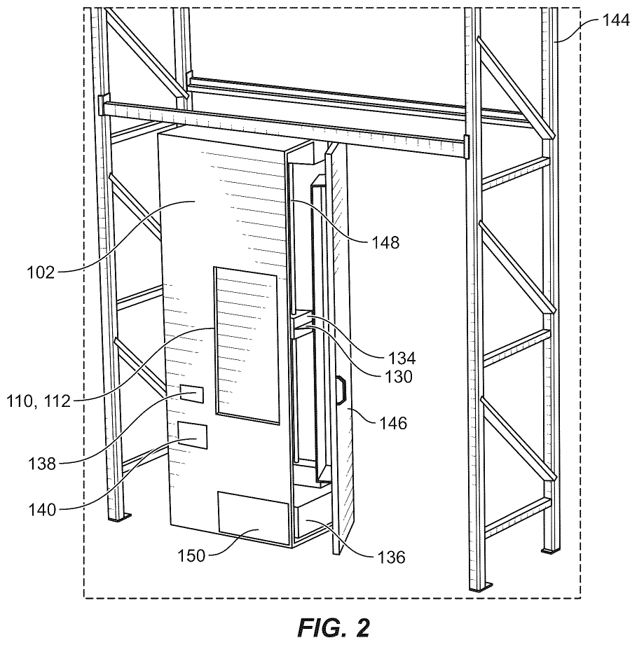

FIG. 1 shows a schematic diagram for a blind cutting system 100, according to some embodiments. The blind cutting system can include a blind cutting kiosk 102. FIG. 2 shows the blind cutting kiosk 102 of FIG. 1, according to some embodiments. FIG. 1 and FIG. 2 will be referenced collectively, unless specifically noted otherwise.

The blind cutting system 100 can generally be used to purchase and customize a window blind. In some embodiments, the blind cutting system 100 can be utilized by a retailer selling various window blinds and shades so a customer or employee of the retailer can purchase a window blind and have the window blind custom sized to meet the customer's requirements.

In the illustrated embodiment, the blind cutting system 100 includes the blind cutting kiosk 102, a server device 104, and a database 106 that are electronically communicable with one another via a network 108. It is to be appreciated that the illustration is an example and that the blind cutting system 100 can vary in architecture. For example, in some embodiments, the blind cutting kiosk 102 may not be electronically connected with the server device 104 and the database 106. Generally, the blind cutting system 100 can include more than one blind cutting kiosk 102. For example, the blind cutting system 100 can include at least one blind cutting kiosk 102 in a first location, and multiple of the blind cutting kiosk 102 can be distributed across various locations (e.g., different retail stores). In some embodiments, the blind cutting system kiosk 102 can be located in a retail environment such as, but not limited to, a retail store. In some embodiments, a user of the blind cutting kiosk 102 can purchase and customize a size of the window blind. In some embodiments, the user can be an operator such as an employee of the retail store in which the blind cutting kiosk is located or can be a consumer purchasing the window blind.

The blind cutting kiosk 102 can include an output device 110 and an input device 112. In some embodiments, the output device 110 can be a display that is configured to display a user interface. In some embodiments, the output device 110 and the input device 112 can be combined. In such embodiments, the output device 110 can be configured to both display the user interface to a user and to receive inputs from the user. That is, the output device 110 can be a display or a display and input device (e.g., a touchscreen or the like).

The blind cutting kiosk 102 can include a processor 114, a memory 116, and a storage 118. In some embodiments, an application 120 can be stored in the storage of the blind cutting kiosk 102 and can be used to, for example, perform a process in which a user is able to purchase a window blind and customize the size of the window blind. In some embodiments, the processor 114 can be a programmable logic controller. In some embodiments, there can be a single human machine interface (HMI) for the user to interact with the blind cutting kiosk 102.

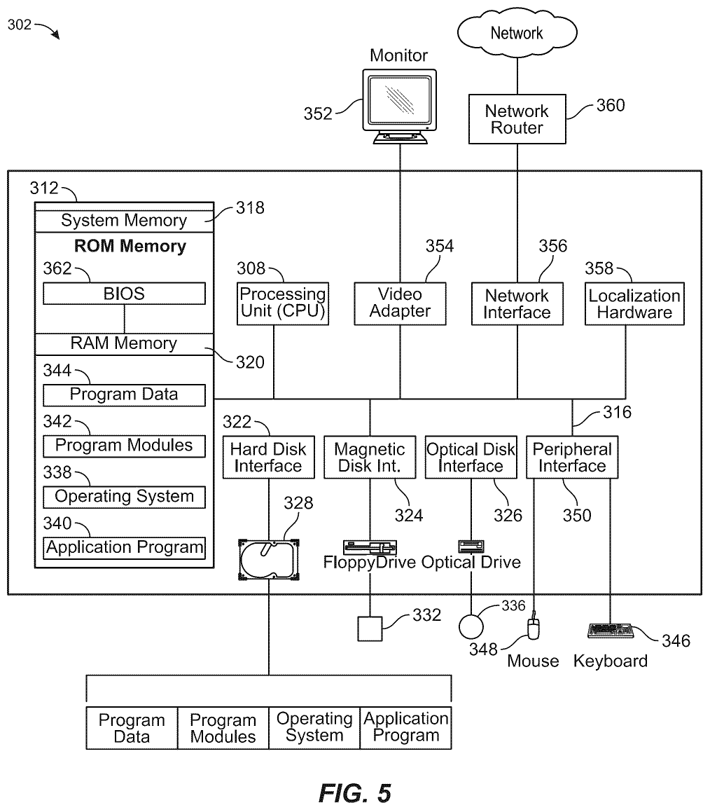

Examples of the inputs for the input device 112 include, but are not limited to, a keyboard, a mouse, a trackball, a button, a voice command, a proximity sensor, a touch sensor, an ocular sensing device for determining an input based on eye movements (e.g., scrolling based on an eye movement), suitable combinations thereof, or the like. The output device 110 and the input device 112 can include aspects that are the same as, or similar to, FIG. 5 below.

In some embodiments, the server device 104 can include a processor 122, a memory 124, and a storage 126. In some embodiments, the application 120 can be stored in the storage 126 of the server device 104 instead of or in addition to the storage 118 of the blind cutting kiosk 102. The server device 104 can include aspects that are the same as, or similar to, FIG. 5 below.

In some embodiments, the network 108 can be representative of the Internet. In some embodiments, the network 108 can include a local area network (LAN), a wide area network (WAN), a wireless network, a cellular data network, combinations thereof, or the like. The network 108 can include a combination of wired communications, wireless communications, or suitable combinations thereof.

The server device 104 is in electronic communication with the database 106. The database 106 can include, among other features, a plurality of information relating to usage of the blind cutting kiosk 102 in the blind cutting system 100. In some embodiments, the blind cutting kiosk 102 may utilize the storage 126 of the server device 104 and may receive updates over the network 108.

It is to be appreciated that various roles of the server device 104 and the database 106 can be distributed among the devices in the blind cutting system 100. For example, in some embodiments, the database 106 can be maintained on the server device 104.

The blind cutting kiosk 102 includes a cutting system 128 having a blade 130, a motor 132, a vertical motion controlled and actuating system 134, a scrap container 136, a packaging dispenser 138, and an accessory dispenser 140. In use, the user is able to insert a window blind in a vertical configuration into the blind cutting kiosk 102. The cutting system 128 is arranged to cut a first end (e.g., a top end of the window blind as arranged in the blind cutting kiosk 102 relative to a floor on which the blind cutting kiosk 102 is placed) and then move the blade 130 and motor 132 vertically downward using the vertical motion controlled and actuating system 134 so that a second end opposite the first end (e.g., a bottom end of the window blind as arranged in the blind cutting kiosk 102 relative to the floor on which the blind cutting kiosk 102 is placed). It is to be appreciated that the opposite cutting order is possible. For example, the first end being cut could be the bottom end and the second end being cut could be the top end. In some embodiments, the blind cutting kiosk 102 includes an integrated vacuum system that can be used to manage dust and debris generated from the cutting process.

In some embodiments, the window blind can be loaded vertically into the blind cutting kiosk 102 while still contained within the packaging. In some embodiments, the packaging can include a cardboard box, plastic, combinations thereof, or the like. In some embodiments, the blind cutting kiosk 102 can also include a Radio Frequency Identification (RFID) reader 142. In such embodiments, the package including the window blind, or the window blind itself can include an RFID tag so that the RFID reader 142 can confirm the expected window blind is loaded into the blind cutting kiosk 102 for cutting. If the incorrect window blind is loaded, the blind cutting kiosk 102 can indicate an error to the user via the output device 110 so that the user is forced to provide the correct window blind. It is to be appreciated that the RFID reader 142 is an example and the blind cutting kiosk 102 can include other manners of confirming whether the correct window blind is loaded. For example, in some embodiments the blind cutting kiosk 102 can include a camera or photo eye that photographs all or a portion of the packaging and compares the image to a stored image in database 106 to confirm the package is correct prior to beginning cutting. In some embodiments, a scannable code such as a QR code, barcode, or the like, can be located on the packaging and a photo or laser reader can confirm the QR code, barcode, or the like aligns with the correct window blind size prior to beginning cutting.

After the window blind is cut to size, the blind cutting kiosk 102 can output one or more pieces of tape or other sealing media via the packaging dispenser 138. In some embodiments, the tape dispensed can be used to reseal the packaging since the window blind is cut while in the packaging. In some embodiments, the packaging dispenser 138 can dispense one or more other supplemental packaging components other than tape. In some embodiments, both ends of the window blind and packaging are cut. In some embodiments, the tape or supplemental packaging dispensed can have a code such as a barcode, QR code, or the like, which can be scanned by a cashier to confirm the user has paid for the window blinds and shades before leaving the retail store. It is to be appreciated that the tape can be dispensed prior to cutting the window blind or during the cutting process and is not limited to after the completion of the cutting process.

In some embodiments, an accessory item such as, but not limited to, hardware used to mount the window blinds and shades to a window can be dispensed via the accessory dispenser 140. As with the tape dispensed, the hardware can be dispensed before the cutting process, during the cutting process, or after the cutting process.

In some embodiments, the scrap container 136 is disposed vertically underneath the window blind cutting location of the blind cutting kiosk 102 so that the cutoff portions are fed by gravity into the scrap container 136, which can then be emptied.

With specific reference to FIG. 2, the blind cutting kiosk 102 is shown in FIG. 2 as being installed within a rack 144 of a retail store. As such, in some embodiments, the blind cutting kiosk 102 can be located in a same location as the window blinds and shades being sold. As illustrated in FIG. 2, by cutting the window blinds and shades vertically instead of horizontally, the blind cutting kiosk 102 is able to fit into the rack 144 with a smaller horizontal footprint within the rack 144. In some embodiments, this can reduce floorspace taken up by the blind cutting kiosk 102 relative to horizontally oriented cutting systems.

As visible in FIG. 2, the blind cutting kiosk 102 includes a door 146 that can be opened to add or remove a window blind to be cut. As also visible in FIG. 2, the cutting system 128 includes at least one structure 148 on which the vertical motion controlled and actuating system 134 is mounted to move the blade 130 and the motor 132 from end to end of the window blind. In some embodiments, the at least one structure 148 can be a rod or the like. In some embodiments, the at least one structure 148 can be a bearing surface or the like. In some embodiments, the at least one structure 148 can permit the vertical motion controlled and actuating system 134 to traverse from end to end of the window blind. It is to be appreciated that there are a variety of methods for the vertical motion controlled and actuating system 134 to be implemented to move the blade 130 and the motor 132. For example, the vertical motion controlled and actuating system 134 can be an electric system using electric motors; a pneumatic system; a system using chains or pulleys; combinations thereof; or the like.

The blind cutting kiosk 102 can include a separate door 150. The separate door 150 can be accessed to remove the scrap container 136 for disposal of the scrap portions cut from the window blinds and shades. In some embodiments, the separate door 150 can additionally or alternatively house a vacuum system or dust collection container.

Referring again to FIG. 1, the blind cutting system 100 can be in communication with a mobile device 152 via the network 108. In some embodiments, the mobile device 152 can be a mobile device that belongs to an associate in the retail setting. In such embodiments, the blind cutting kiosk 102 can send a notification to the mobile device 152 via the network so that an associate can provide additional customer service to the individual using the blind cutting kiosk 102. In some embodiments, the mobile device 152 is a device that allows associates to communicate, take store phone calls, look up merchandise locations within the store, in-stock/inventory numbers, scan items for pricing, scan barcodes to alert store inventory management when product levels are low, combinations thereof, or the like. In some embodiments, if an online order is placed for a custom window blind, the mobile device 152 can receive an alert so the associate can prepare the order using the blind cutting kiosk 102 for the customer to pick up in the store. In some embodiments, the blind cutting kiosk 102 can be configured to send a notification to a customer when the associate finishes the cutting of the window blind according to the customer's specifications. In some embodiments, the blind cutting kiosk 102 can be configured to notify the associate of a defect or alert the associate to an issue with the blind cutting kiosk 102 so the associate can initiate a preventative maintenance task.

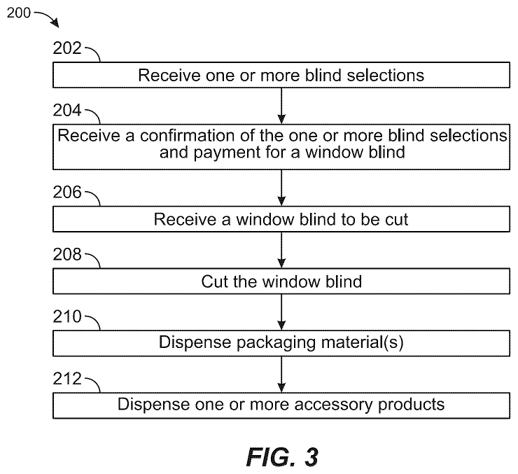

FIG. 3 shows a flowchart of a method for resizing a window blind, according to some embodiments. The method 200 can enable a user (e.g., a consumer or the like) to purchase and customize a size of a window blind.

At block 202, the method 200 includes receiving one or more blind selections. The one or more blind selections can include, for example, a type of the window blind being purchased by the user, a dimension of the window in which the window blind is going to be installed, or the like. In some embodiments, the user may have to enter one or more details of the one or more blind selections while others of the one or more blind selections may be determined based on an identifier on a package of the selected window blind. For example, in some embodiments, the user may scan a barcode or other code including, but not limited to, a proximity reader such as an RFID tag to determine one or more of the one or more blind selections such as, but not limited to, the type of window blind, the dimension of the window blind, combinations thereof, or the like. In some embodiments, the user may enter others of the one or more blind selections, such as, but not limited to, the dimension of the window in which the window blind is going to be installed. In some embodiments, the dimension of the window can be used to estimate a final dimension of the window blind after cutting. In some embodiments, the user can input the desired dimension of the window blind after cutting.

In some embodiments, one or more of the one or more blind selections may be done at the blind cutting kiosk 102 or may be done remotely. For example, a user may be able to prepare one or more selections via a computing device separate from the blind cutting kiosk 102. In such embodiments, the user may even be able to pay on the remote computing device prior to coming to the store. In some embodiments, the user may then be able to retrieve the order at the blind cutting kiosk 102 instead of making the one or more blind selections at the blind cutting kiosk 102.

In some embodiments, the blind cutting kiosk 102 can automatically calculate a cut dimension based on a size of a window input by the user. In some embodiments, the user may provide a window dimension and select whether the blind will set inside of a window frame or outside the window frame. In such embodiments, the blind cutting kiosk 102 calculates the blind dimensions and accordingly the appropriate cuts to be made by the blind cutting kiosk 102.

Optionally, in some embodiments, the blind cutting kiosk 102 can send an electronic notification to a mobile device (e.g., the mobile device 152) of a store associate so that the store associate is aware a user is at the blind cutting kiosk 102 and can provide additional customer service to the user.

At block 204, the method 200 includes receiving a confirmation of the one or more blind selections and pays for the window blind. In some embodiments, the blind cutting kiosk 102 can include a payment terminal via which the user is able to make an electronic payment such as, but not limited to, via a credit card or other electronic form of payment.

At block 206, the method 200 includes receiving a window blind to be cut within the blind cutting kiosk 102.

At block 208, the method 200 includes cutting the window blind.

At block 210, the method 200 includes dispensing tape segments, an end cap, cover material, or combinations thereof, so the user can reseal the packaging.

At block 212, the method 200 includes dispensing one or more accessory products.

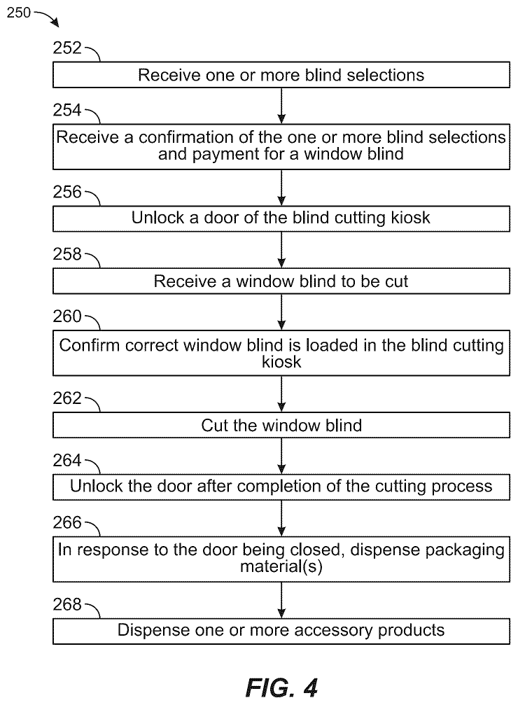

FIG. 4 shows a flowchart of a method 250 for cutting a window blind, according to some embodiments. It is to be appreciated that aspects of the method 250 can be the same as or similar to aspects of the method 200. The method 250 can enable a user (e.g., a consumer or the like) to purchase and customize a size of a window blind.

At block 252, the method 250 includes receiving one or more blind selections. The one or more blind selections can include, for example, a type of the window blind being purchased by the user, a dimension of the window in which the window blind is going to be installed, or the like. In some embodiments, the user may have to enter one or more details of the one or more blind selections while others of the one or more blind selections may be determined based on an identifier on a package of the selected window blind. For example, in some embodiments, the user may scan a barcode or other code including, but not limited to, a proximity reader such as an RFID tag to determine one or more of the one or more blind selections such as, but not limited to, the type of window blind, the dimension of the window blind, combinations thereof, or the like. In some embodiments, the user may enter others of the one or more blind selections, such as, but not limited to, the dimension of the window in which the window blind is going to be installed. In some embodiments, the dimension of the window can be used to estimate a final dimension of the window blind after cutting. In some embodiments, the user can input the desired dimension of the window blind after cutting.

At block 254, the method 250 includes receiving a confirmation of the one or more blind selections and pays for the window blind. In some embodiments, the blind cutting kiosk 102 can include a payment terminal via which the user is able to make an electronic payment such as, but not limited to, via a credit card or other electronic form of payment.

At block 256, the method 250 includes unlocking the door 146 of the blind cutting kiosk 102. In some embodiments, the output device 110 can display instructions for the user to follow to simplify the process and prevent confusion or improper operation of the blind cutting kiosk 102.

At block 258, the method 250 includes receiving a window blind to be cut within the blind cutting kiosk 102. After the window blind is received, the door 146 is closed and is automatically locked upon being closed.

At block 260, the method 250 includes using the reader 142 to read an RFID tag associated with the window blind to determine whether the correct window blind has been loaded (based on the information entered by the user at block 252). In some embodiments, the window blind has an RFID tag included in a headrail of the window blind. In some embodiments, the RFID tag can be included in product packaging for the window blind. In some embodiments, if the reading identifies that the wrong window blind was installed (e.g., the RFID tag does not match the expected RFID tag based on the entered information), an error may be displayed on the output device 110 and the cutting process prevented from moving forward until the proper window blind is inserted into the blind cutting kiosk 102.

At block 262, the method 250 includes cutting the window blind. At block 262, the cutting process can include moving the blade 130 and the motor 132 into position to cut a first end of the window blind. In some embodiments, the first end is the top end of the window blind. In some embodiments, after making the first cut, the blade 130 is moved into position to cut a second end of the window blind. In some embodiments, the second end is the bottom end of the window blind. In some embodiments, prior to cutting the second end, a plate on which the window blind is resting may be moved out of the way so that the bottom end can fall via gravity after being cut.

At block 264, the method 250 includes automatically unlocking the door 146 after the cutting process of block 262 is complete.

In some embodiments, the method 250 may be paused until the user removes the window blind and closes the door 146 again.

At block 266, in response to the door 146 being closed, the method 250 includes dispensing tape segments, end cap, cover material, or combinations thereof, so the user can reseal the packaging.

At block 268, the method 250 includes dispensing one or more accessory products. In some embodiments, the one or more accessory products include mounting hardware for installing the window blind.

FIG. 5 is a diagrammatic view of an illustrative computing system that includes a general-purpose computing system environment 302, having the ability to execute instructions, such as those stored within a non-transient, computer-readable medium. Furthermore, while described and illustrated in the context of a single computing system, those skilled in the art will also appreciate that the various tasks described hereinafter may be practiced in a distributed environment having multiple computing systems linked via a local or wide-area network in which the executable instructions may be associated with and/or executed by one or more of multiple computing systems. One or more of the components of the computing system environment 302 can be included in the blind cutting kiosk 102 and the server device 104 (FIG. 1).

In its most basic configuration, computing system environment 302 typically includes at least one processing unit 308 and at least one memory 312, which may be linked via a bus 316. Depending on the exact configuration and type of computing system environment, memory 312 may be non-volatile (such as ROM 318, flash memory, etc.), volatile (such as RAM 320), or some combination of the two. Computing system environment 302 may have additional features and/or functionality. For example, computing system environment 302 may also include additional storage (removable and/or non-removable) including, but not limited to, magnetic or optical disks, tape drives and/or flash drives. Such additional memory devices may be made accessible to the computing system environment 302 by means of, for example, a hard disk drive interface 322, a magnetic disk drive interface 324, an optical disk drive interface 326, or combinations thereof. As will be understood, these devices, which would be linked to the system bus 316, respectively, allow for reading from and writing to a hard disk 328, reading from or writing to a removable magnetic disk 332, reading from or writing to a removable optical disk 336, such as a CD/DVD ROM or other optical media, or combinations thereof. The drive interfaces and their associated computer-readable media allow for the nonvolatile storage of computer readable instructions, data structures, program modules and other data for the computing system environment 302. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 302.

Several program modules may be stored in one or more of the memory/media devices. For example, a basic input/output system (BIOS) 362, containing the basic routines that help to transfer information between elements within the computing system environment 302, such as during start-up, may be stored in ROM 318. Similarly, RAM 320, hard disk 328, and/or peripheral memory devices may be used to store computer executable instructions comprising an operating system 338, one or more applications programs 340 (such as the application 120 (FIG. 1) for operating the blind cutting kiosk 102), other program modules 342, and/or program data 344. Still further, computer-executable instructions may be downloaded to the computing environment 302 as needed, for example, via a network connection.

An end-user may enter commands and information into the computing system environment 302 through input devices such as a keyboard 346 and/or a pointing device 348 or a touchscreen interface. While not illustrated, other input devices may include a microphone, a joystick, a game pad, a scanner, etc. These and other input devices would typically be connected to the processing unit 308 by means of a peripheral interface 350 which, in turn, would be coupled to bus 316. Input devices may be directly or indirectly connected to processing unit 308 via interfaces such as, for example, a parallel port, game port, firewire, or a universal serial bus (USB). To view information from the computing system environment 302, a monitor 352 or other type of display device may also be connected to bus 316 via an interface, such as via video adapter 354. In addition to the monitor 352, the computing system environment 302 may also include other peripheral output devices, not shown, such as speakers and printers.

The computing system environment 302 may also utilize logical connections to one or more computing system environments. Communications between the computing system environment 302 and the remote computing system environment may be exchanged via a further processing device, such a network router 360, that is responsible for network routing. Communications with the network router 360 may be performed via a network interface component 356. Thus, within such a networked environment, e.g., the Internet, World Wide Web, LAN, or other like type of wired or wireless network, it will be appreciated that program modules depicted relative to the computing system environment 302, or portions thereof, may be stored in the memory storage device(s) of the computing system environment 302.

The computing system environment 302 may also include localization hardware 358 for determining a location of the computing system environment 302. In embodiments, the localization hardware 358 may include, for example only, a GPS antenna, an RFID chip or reader, a Wi-Fi antenna, or other computing hardware that may be used to capture or transmit signals that may be used to determine the location of the computing system environment 302.

Examples of computer-readable storage media include, but are not limited to, any tangible medium capable of storing a computer program for use by a programmable processing device to perform functions described herein by operating on input data and generating an output. A computer program is a set of instructions that can be used, directly or indirectly, in a computer system to perform a certain function or determine a certain result. Examples of computer-readable storage media include, but are not limited to, a floppy disk; a hard disk; a random access memory (RAM); a read-only memory (ROM); a semiconductor memory device such as, but not limited to, an erasable programmable read-only memory (EPROM), an electrically erasable programmable read-only memory (EEPROM), Flash memory, or the like; a portable compact disk read-only memory (CD-ROM); an optical storage device; a magnetic storage device; other similar device; or suitable combinations of the foregoing.

It is to be appreciated that one or more of the components may not be included in the blind cutting kiosk 102. For example, the blind cutting kiosk 102 may not include any local storage media.

In some embodiments, hardwired circuitry may be used in combination with software instructions. Thus, the description is not limited to any specific combination of hardware circuitry and software instructions, nor to any source for the instructions executed by the data processing system.

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be:
disposed directly between both of the two other structural elements such that the particular structural component is in direct contact with both of the two other structural elements;
disposed directly next to only one of the two other structural elements such that the particular structural component is in direct contact with only one of the two other structural elements;
disposed indirectly next to only one of the two other structural elements such that the particular structural component is not in direct contact with only one of the two other structural elements, and there is another element which juxtaposes the particular structural component and the one of the two other structural elements;
disposed indirectly between both of the two other structural elements such that the particular structural component is not in direct contact with both of the two other structural elements, and other features can be disposed therebetween; or any combination(s) thereof.

1. A blind cutting kiosk comprising:
an input device configured to receive one or more inputs;
an output device configured to display one or more outputs;
wherein the input device and the output device are configured to display a user interface; and
a cutting system configured to receive a vertically arranged window blind.

2. The blind cutting kiosk of claim 1, wherein the cutting system comprises a blade, a motor, and a vertical motion controlled and actuating system.

3. The blind cutting kiosk of claim 2, wherein the vertical motion controlled and actuating system is configured to move the blade and the motor vertically along a width of the vertically arranged window blind.

4. The blind cutting kiosk of claim 1, further comprising a vacuum system.

5. The blind cutting kiosk of claim 1, further comprising an accessory dispenser configured to dispense an accessory item for the vertically arranged window blind.

6. The blind cutting kiosk of claim 1, wherein the cutting system is configured to receive the vertically arranged window blind within a product package of the vertically arranged window blind.

7. The blind cutting kiosk of claim 1, comprising at least one of a Radio Frequency Identification (RFID) reader, a photo eye, a camera, a QR code reader, or a barcode reader.

8. The blind cutting kiosk of claim 7, wherein the RFID reader is configured to read an RFID tag associated with the vertically arranged window blind to determine whether the vertically arranged window blind matches an expected window blind.

9. The blind cutting kiosk of claim 1, further comprising a packaging dispenser configured to dispense one or more pieces of tape, an end cap, cover material, or combinations thereof, for the vertically arranged window blind.

10. A blind cutting system comprising:
a blind cutting kiosk comprising:
an input device configured to receive one or more inputs;
an output device configured to display one or more outputs;
wherein the input device and the output device are configured to display a user interface; and
a cutting system configured to receive a vertically arranged window blind;
and
a server device configured to electrically communicate with the blind cutting kiosk via a network.

11. The blind cutting system of claim 10, wherein the cutting system comprises a blade, a motor, and a vertical motion controlled and actuating system.

12. The blind cutting system of claim 11, wherein the vertical motion controlled and actuating system is configured to move the blade and the motor vertically along a width of the vertically arranged window blind.

13. The blind cutting system of claim 12, further comprising a vacuum system.

14. The blind cutting system of claim 11, further comprising an accessory dispenser configured to dispense an accessory item for the vertically arranged window blind.

15. The blind cutting system of claim 11, wherein the cutting system is configured to receive the vertically arranged window blind within a product package of the vertically arranged window blind.

16. The blind cutting system of claim 11, comprising at least one of a Radio Frequency Identification (RFID) reader, a photo eye, a camera, a QR code reader, or a barcode reader.

17. The blind cutting system of claim 11, wherein the server device is configured to receive information relating to usage of the blind cutting kiosk.

18. A method comprising:
receiving one or more blind selections via an input device on a blind cutting kiosk, the one or more blind selections defining a custom dimension of a window blind;
in response to an indication that a payment for the window blind is complete, cutting a window blind using the custom dimension of the window blind; and
dispensing one or more of tape segments or accessory products from the blind cutting kiosk.

19. The method of claim 18, further comprising receiving the window blind, wherein the window blind is contained within packaging.

20. The method of claim 18, further comprising reading, by a Radio Frequency Identification (RFID) reader, an RFID tag associated with the window blind; and
in response to the RFID tag matching an expected RFID tag based on the one or more blind selections, cutting the window blind using the custom dimension of the window blind.
